(19) United States
(12) Patent Application Publication
(10) Pub. No.: US 2004/0263886 A1
(43) Pub. Date: Dec. 30, 2004

(54) Proofing method and system therefore

(76) Inventor: Stefan Livens, Wijnegem (BE)

Correspondence Address: Agfa Corporation, Law & Patent Department, 200 Ballardvale Street, Wilmington, MA, 01887-1069, US

(21) Appl. No.: 10/863,441

(22) Filed: Jun. 8, 2004

Related U.S. Application Data
(60) Provisional application No. 60/490,207, filed on Jul. 25, 2003.

(30) Foreign Application Priority Data
Jun. 30, 2003 (EP) EP 03101942.5

(51) Int. Cl. H04N 1/52; H04N 1/56; H04N 1/60

(52) U.S. Cl. 358/1.9; 358/536; 358/518; 358/1.2

(57) ABSTRACT

A method and an apparatus for proofing an image on a proofing device having a set of ColB colorants at a proofing resolution ResB, wherein the image is to be output on an output device having a set of ColA colorants at a resolution ResA different from ResB, the method including (a) providing the image in a first representation having the set of ColA colorants and the resolution ResA; (b) converting the image to a second, intermediate representation having the resolution ResA and an intermediate color set that is different from the set of ColA colorants and different from the set of ColB colorants; (c) converting the image from the second, intermediate representation to a third, intermediate representation having the intermediate color set and the resolution ResB; (d) converting the image from the third, intermediate representation to a fourth representation having the set of ColB colorants and the resolution ResB.

This application claims the benefit of U.S. Provisional Application No. 60/490,207 filed Jul. 25, 2003.

### FIELD OF THE INVENTION

The present invention relates to the conversion of image data between devices; the invention especially concerns the generation of image data for a digital proofing device.

### BACKGROUND OF THE INVENTION

In the reproduction of images, very often a proof is made that simulates the image that is to be reproduced. Such a proof serves several purposes. On the one hand, the customer, who wants the image to be reproduced, can see in advance what the reproduction will look like, and can therefore still ask for modifications if required. On the other hand, the printer—assuming that the image is to be reproduced by printing—has an example of the image to be reproduced and hence he is able to check if his prints are correct. If errors show up, the printer can decide to apply corrections to his printing system or to stop the printing process.

A so-called contract proof is used in an agreement between the customer, or print buyer, and the print supplier. The customer agrees that the contract proof accurately represents what he wants the reproduced document to look like, and the print supplier agrees that he will be able to reproduce the document in that way. Contract proofing demands very high quality and reproducibility.

In this document, the term output device designates the device on which the image is to be reproduced, while the term proofing device or proofer is used for the device that simulates the output device. The proofing device is often a high quality printing device, such as a high quality ink-jet printer. The proofing device may however also be a display screen, in case of so-called soft proofing. The image is then simulated on a display, instead of producing the proof on a receiving substrate such as paper.

The output device and the proofing device both use colorants; e.g. the colorants of an offset press are the offset printing inks, which are very often cyan (C), magenta (M), yellow (Y) and black (K). A colorant designates in this document an independent variable with which a printing device, such as the output device or the proofing device, can be addressed. A colorant value is an independent value that can be used to control a colorant of the printing device. It is customary to express the range of physically achievable values for the colorants of a device in %, which means that usually the colorant values range from 0% to 100%. Information on colorants, colorant spaces, and other relevant terms is available in European patent application no. EP-A-1 083 739 herein incorporated in its entirety for background information only.

In conventional analog proofing systems, such as Agfaproof™ offered by Agfa-Gevaert, color separations on film are used, and the colorants are made in such a way that they correspond to those of the printing device that is simulated. In this way, the printing process can be simulated very well.

Nowadays, to simulate a printing process predominantly other techniques are used, such as electrophotography, ink jet, dye sublimation, thermal transfer printers. Compared to conventional proofing systems, these new systems are in most cases easier to use, cheaper and robust, and in general they offer more functionality. However, these new proofing systems have different printing characteristics compared to the system to be simulated, such as a different resolution, a different rendering to produce color shades, the availability of multiple levels and different colorants to name a few.

Because of the difference in colorants, colorant values of the output device cannot be used to control the proofer. To resolve this issue, color management transformations may be applied. A widely used system to transfer colorant values from one device to another one is provided by the ICC profile format (ICC stands for International Color Consortium).

Besides color, another important characteristic in high quality color proofing, and especially in contract proofing, is the screening that is used. Screening (or halftoning) techniques, such as Agfa's ABS™ or CristalRaster™, are used to simulate continuous tones on devices that are not capable of reproducing a continuous range of tones. An offset printing press for example can either deposit ink or not, and is thus a binary printing device.

To reproduce images, the normal workflow is to make first a color separation of the images to the colorant space of the printing process (e.g. a CMYK space), and then to apply a screening mechanism to the resulting values, as in most cases two levels (for a binary printer) or at most a few levels (for a multilevel printer) can be reproduced. The resulting image is a reduced bit image. For a binary printer, a binary image is obtained per colorant used, whereas in case of a 2 bit multilevel printer, 2 bit images are obtained for each colorant.

For a good simulation of both color and screening, the dots as printed by the output device to be simulated have to be reproduced accurately. This is realized in a proofing method that is called dot for dot proofing. In dot for dot proofing, the appearance of an image on an output device is simulated on a proofing device, wherein the appearance includes color, screening properties, possibly sharpness. Also artifacts, such as moire, and limitations of the output on the output device are simulated on the proofing device in a dot for dot proof.

The output device and the proofing device can differ in many properties, such as: different colorants, possibly a different number of colorants; different resolutions (typically 720 dpi, i.e. dots per inch, for the proofing device and 1200 dpi or 2400 dpi for the output device); different physical properties, ink, paper and their interaction, which may result in different dot gains, different sizes of the minimal dot that can be reproduced consistently, etc.

Known methods for dot for dot proofing therefore include a resolution conversion and a color conversion of images from the output device to the proofing device. European patent application no. EP-A-1 139 654 and U.S. Pat. Nos. 5,854,883 and 5,526,140 are incorporated herein in their entirety for background information only. In EP-A-1 139 654, first a color conversion is applied and then a resolution conversion. U.S. Pat. No. 5,854,883 describes a method wherein a resolution conversion is followed by a color conversion. The above European patent application and U.S. patent also provide information on dot for dot proofing.

U.S. Pat. No. 5,526,140 discloses a system and method for representing a multi-color, halftone image on a multi-color, continuous-tone device, wherein the system and method can be configured to employ an approximation technique for determining areas of overlap regions produced by adjacent device spots in a printed halftone image based on a halftone device model. The halftone device model may be used to generate continuous-tone color values output as CIE XYZ tristimulus values.

There is still a need for an improved method for dot for dot proofing.

### SUMMARY OF THE INVENTION

The present invention includes a method for proofing an image on a proofing device as claimed in independent claim 1, a method for converting an image as claimed in independent claim 9, and an apparatus as claimed in independent claims 15 and 17. Preferred embodiments of the invention are set out in the dependent claims. Preferably, a method in accordance with the invention is implemented by a computer program as claimed in claims 7 and 12. The invention also includes a proof made by a method or an apparatus as claimed.

In a preferred embodiment of the invention, image data are converted from an output device to a proofing device via an intermediate representation of the image, wherein the intermediate representation has an intermediate color set that is different from the color set of the output device and different from the color set of the proofing device.

The invention can be applied to the conversion of image data across devices, wherein the appearance of the output image on one device simulates the appearance on another device. The appearance preferably includes color, halftoning (screening), sharpness. The device of which the output is simulated is called device A, and the device that produces the simulation is called device B. A preferred application of the invention is digital proofing. The invention will be described particularly for the case where device A is a binary hardcopy printing device, such as an offset printing press, and where device B is a proofing device, also called proofer, such as an ink jet printer. The invention is however not limited to this case.

In one embodiment of the invention, the so-called Neugebauer primaries are used as the intermediate representation. The Neugebauer primaries are combinations of the colorants; for the four colorants CMYK, the Neugebauer primaries are the 2⁴=16 different color combinations of C, M, Y and K.

It is preferred to use a representation in a device independent space, such as CIELab or CIE XYZ, as intermediate representation.

An advantage of the invention is that a very high quality simulation on device B (the proofer) is obtained of the appearance of the output image on device A (the output device).

Another advantage is that the calculation of the image for the proofing device may start directly from bitmaps for the output device; this allows a truthful simulation.

Further advantages and embodiments of the present invention will become apparent from the following description and drawings.

### BRIEF DESCRIPTION OF THE DRAWINGS

The invention is described with reference to the following drawings without the intention to limit the invention thereto, and in which:

FIG. 1 illustrates a general flow for the conversion of image data across devices;

FIG. 2 shows a prior art flow for such a conversion;

FIG. 3 illustrates another prior art flow for such a conversion; and

FIG. 4 shows an embodiment of such a conversion in accordance with the invention.

### DETAILED DESCRIPTION OF THE PREFERRED EMBODIMENTS

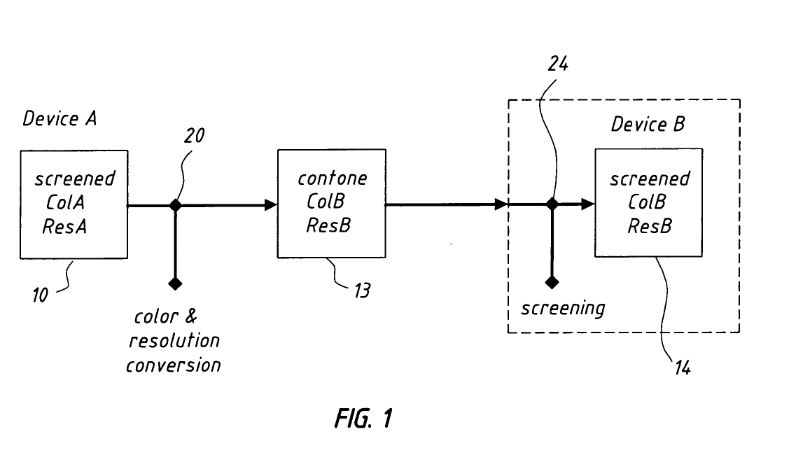

FIG. 1 shows a general flow for the conversion of image data from a first device, device A, having a set of ColA colorants and a resolution ResA, to a second device, device B, that has a set of ColB colorants and a resolution ResB. The image data are available as a screened representation 10 for device A, using a set of ColA colorants (e.g. CMYK) at a resolution ResA (e.g. 2400 dpi). These image data are converted, by a color and resolution conversion 20, to a contone (i.e. continuous tone) representation 13 with ColB colorants and resolution ResB (e.g. 720 dpi). In case the sets of ColA colorants and of ColB colorants are both CMYK, these sets of CMYK colorants will in general still be different, because the inks that are used for device A respectively for device B have, in general, different properties. If device B also works with screened data, the contone representation 13 is converted by a screening step 24 to a screened representation 14. This optional step 14 is enclosed by a dashed line in FIG. 1.

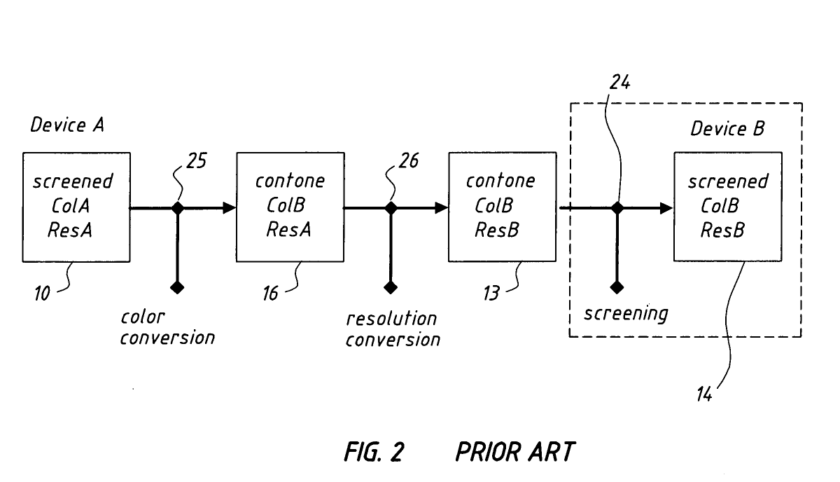

FIG. 2 shows the prior art flow that corresponds to EP-A-1 139 654. First, an image having a screened representation 10 with ColA colorants at resolution ResA is converted, in color conversion step 25, to a contone representation 16 having ColB colorants, still at resolution ResA. Subsequently, a resolution conversion 26 is applied, to obtain contone representation 13, with ColB colorants but now at resolution ResB. Optionally, step 24 is applied to obtain screened representation 14 for device B, with ColB colorants at resolution ResB. More details of this prior art flow, including examples of the colorants and resolutions, can be found in EP-A-1 139 654.

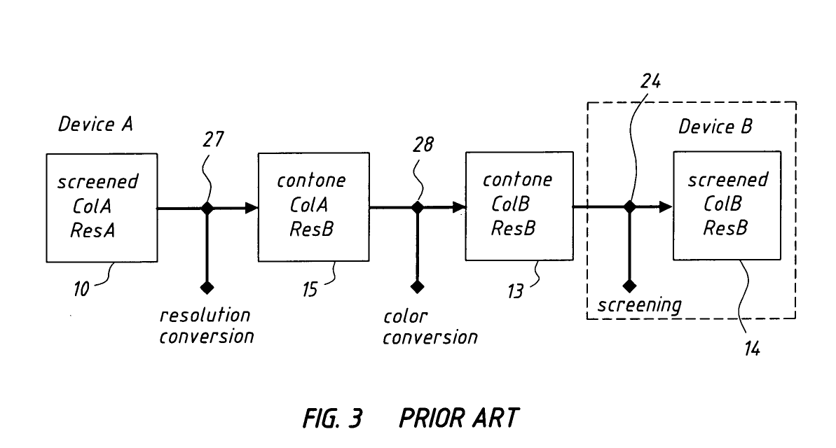

In the prior art flow of FIG. 3, the order of the color conversion and the resolution conversion is reversed with respect to FIG. 2. The flow of FIG. 3 is very different from the one of FIG. 2, since both the color conversion and the resolution conversion act on images of a different nature. For the flow of FIG. 2, the color conversion 25 starts from binary images 10, which results in a small number of different possibilities in the output (see also EP-A-1 139 654). In FIG. 3, the color conversion 28 is performed between contone images 15, 13, which can generate many more possible outcomes. The flow of FIG. 3 corresponds to U.S. Pat. No. 5,854,883. First, an image having a screened representation 10 with ColA colorants at resolution ResA is converted, in resolution conversion step 27, to a contone representation 15 having ColA colorants at resolution ResB. The resolution conversion step 27 is also known as resampling (see U.S. Pat. No. 5,854,883). In most practical cases, ResB<ResA, so that downsampling is performed. Subsequently, a color conversion 28 is applied, to obtain contone representation 13, with ColB colorants at resolution ResB. Optionally, step 24 is applied to obtain screened representation 14 for device B, with ColB colorants at resolution ResB.

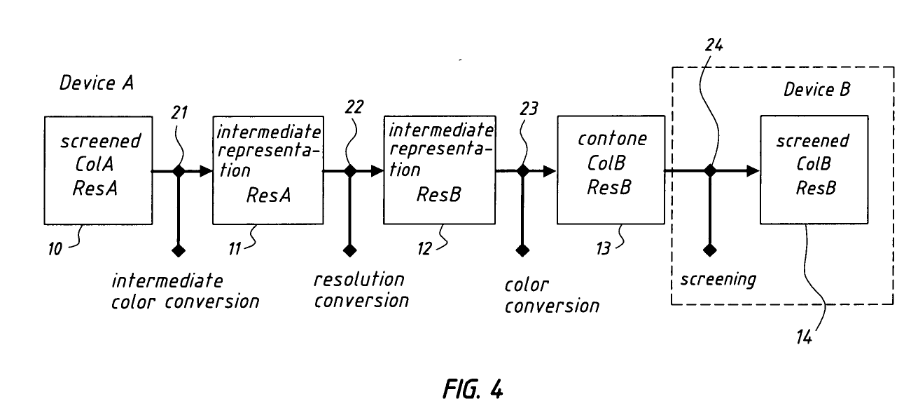

FIG. 4 illustrates an embodiment in accordance with the invention, wherein an image is provided in a representation 10 having the set of ColA colorants of device A. The image is converted to an intermediate representation 11, having an intermediate color set that is different from the set of ColA colorants, and also different from the set of ColB colorants of device B.

As shown in FIG. 4, several conversion steps 21-24 may be performed, among which the resolution conversion 22 that acts on an image in the intermediate representation 11. First, the image having a screened representation 10 with ColA colorants at resolution ResA is converted, in intermediate color conversion step 21, to an intermediate representation 11 at resolution ResA. Then a resolution conversion 22 is applied, to obtain the image in the intermediate representation 12 at resolution ResB. Subsequently, color conversion step 23 converts the image to contone representation 13, with ColB colorants at resolution ResB. Optionally, step 24 is applied to obtain screened representation 14 for device B, with ColB colorants at resolution ResB.

This embodiment in accordance with the invention has several advantages over the prior art flows of FIG. 2 and FIG. 3; these advantages will now be discussed.

In a general flow, as illustrated in FIG. 1, the input image contains a number ColA of binary channels (e.g. for CMYK colorants, ColA=4, while ColA>4 in case CMYK and one or more spot colors, such as Pantone™ colors, are used).

In the prior art flow of FIG. 3, the resolution conversion 27 is performed, channel per channel, on the original binary data and results in intermediate values (such as the “50%” of the example discussed below). The computational cost of the resolution conversion 27 increases with the number of spot colors, as these are represented in separate channels. Moreover, the color conversion 28 is more complex than in the case of FIG. 2, because of the intermediate values. The most important disadvantage is that information about the amount of overlap between the channels is lost during the resolution conversion 27. This is illustrated by the following example:

If four pixels, of which two cyan (C) and two magenta (M), are averaged out in the resolution conversion, the result is 50% C and 50% M. This result could however also arise from two other configurations (assuming that an unprinted pixel is white): on the one hand the configuration: two pixels C+M, two white pixels; and on the other hand the configuration: one pixel C+M; one pixel C, one pixel M and one white pixel. The average visual color of the configurations is clearly different because of the differences in overlap. By performing the resolution conversion on the input colorant space, this cannot be accounted for correctly.

In the prior art flow of FIG. 2, the color conversion 25 is performed first. In this way, the overlap can correctly be taken into account and correct output colorant values are generated. However, the resolution conversion 26 performs some averaging of these output values (assuming that ResB<ResA, which is the usual case). Because of the effect of dot gain, averaging leads to incorrect colors.

In the embodiment according to the invention wherein the Neugebauer primaries are used as the intermediate representation, every one of the 2^{ColA} combinations of the input channels is represented in a separate channel. Thus, referring to FIG. 4, the image is represented, in intermediate representation 11, by 2^{ColA} channels, each one at a resolution ResA. The resolution conversion 22 acts on these 2^{ColA} channels, so that all information about overlap is maintained during the resolution conversion. Moreover, the color conversion 23 takes place at the resolution ResB of the output device, so that no dot gain related averaging errors are introduced.

In this embodiment, the number of channels is larger than for prior art flows (2⁴=16 instead of 4 in case of CMYK), and therefore more data have to be processed during the resolution conversion 22. However, the computational complexity of the color conversion 23 is lower. For images with a large number of spot colors, a hybrid intermediate representation can be used. In such a hybrid intermediate representation, the most important overlaps are represented in separate channels (usually those of the process colors CMYK, possibly also one or a few spot colors), while for each of the other colors a single channel is used.

In a preferred embodiment of the invention, the input data are converted (referring to FIG. 4, in step 21) to a device independent color space such as CIE XYZ or CIELab, before the resolution conversion 22. Then only three channels need to be processed, which is an advantage over all previous cases. More important is that the averaging of data will not result in color errors as in the prior art flows discussed above.

For spaces which are perceptually uniform or approximately perceptually uniform, such as CIELab, the averaging results in a correct visual average. Additionally, computational limitations such as rounding errors have the least visual influence. For CIE XYZ, which directly relates to the amount of light, the averaging is physically justified because of the additivity of light.

The use of a device independent intermediate representation does not exclude the transfer of specific information about the input image, such as the ink amount of a specific ink (e.g. black or a spot color), or a derived property, e.g. the total ink amount. One or more additional channels can be added to the intermediate representation. These channels can trigger modifications in the color conversion 23 from the intermediate representation 12 to the output representation 13. An advantage of an additional channel for black is that some or all black items in the input image may be represented as pure black in the output image.

The invention is not limited to the embodiments discussed above.

In the flow of FIG. 4 e.g., additional steps may be added.

In FIG. 4, the representation 10 of the input image has the resolution ResA of device A, i.e. the output device. This is preferred since the calculation of the image for the proofing device thus starts directly from bitmaps for the output device, which allows a truthful simulation. However, the resolution of the input image, i.e. the resolution of representation 10, may also be different from ResA, as is e.g. the case in the embodiment of EP-A-1 139 654, FIG. 2, where resolution Res3 is different from resolution Res1.

In most cases, the set of ColA colorants is different from the set of ColB colorants. The case where they are equal is however also a useful embodiment of the invention. A typical example is the following one. An image is prepared, and screened data are provided, for printing on a device A. The image data are provided in a specific resolution. The image is to be reproduced on device A, or on a different device that uses the same or similar colorants as device A, but at a resolution that is different from the given, specific resolution.

Performing a resolution conversion in the colorant space ColA generally leads to results that are different in color from the original colors due to (amongst other causes) the difference in dot gain at different resolutions.

When the present invention is applied to this case, with ColA equal to ColB, the resolution conversion is performed in the intermediate representation. Preferably, the intermediate representation is a device independent color space such as CIE XYZ or CIELab. An advantage of the invention in this case is that the image reproduction is more color accurate. In this embodiment of the invention, device B may equal device A, i.e. the proofing device and the output device may be identical.

Further, a dot for dot proofing system is set up to produce halftoning screens. However, the invention is by no means limited to classical AM screening (AM screening stands for amplitude modulated screening, of which Agfa's ABS™ is an example). The invention preferably starts from the halftoned data, and assumes no specific properties of them. Naturally, it is preferred that the inverse halftoning method employed is well suited to the halftoning used.

For hybrid screens, such as Agfa's Sublima™, very little needs to be changed compared to AM screening. The invention can also be applied to stochastic screening or FM screening (FM screening stands for frequency modulated screening, of which Agfa's CristalRaster™ is an example). For application to FM screening, the dots are typically all small. Therefore, preferably a different tuning of the parameters is performed in order to achieve optimal output quality.

Those skilled in the art will appreciate that numerous modifications and variations may be made to the embodiments disclosed above without departing from the scope of the present invention.

1. A method for proofing an image on a proofing device having a set of ColB colorants at a proofing resolution ResB, wherein said image is to be output on an output device at a resolution ResA different from said resolution ResB and wherein said output device has a set of ColA colorants with ColA different from ColB, the method comprising the steps of:
providing said image in a first representation having said set of ColA colorants and said resolution ResA;
converting said image to a second, intermediate representation having said resolution ResA and an intermediate color set that is different from said set of ColA colorants and different from said set of ColB colorants;
converting said image from said second, intermediate representation to a third, intermediate representation having said intermediate color set and said resolution ResB; and
converting said image from said third, intermediate representation to a fourth representation having said set of ColB colorants and said resolution ResB.

2. The method according to claim 1 further comprising the steps of:
providing an additional channel with data on said image in said first representation; and
using said data in said conversion of said image to said fourth representation.

3. The method according to claim 1 wherein said second, intermediate representation is a representation in a device independent color space.

4. The method according to claim 2 wherein said second, intermediate representation is a representation in a device independent color space.

5. The method according to claim 1 wherein said second, intermediate representation is a Neugebauer primaries representation.

6. The method according to claim 2 wherein said second, intermediate representation is a Neugebauer primaries representation.

7. A computer program comprising computer program code means adapted to perform the method of claim 1 when said program is run on a computer.

8. A computer readable medium comprising program code adapted to carry out the method according to claim 1 when run on a computer.

9. A method for converting an image having a set of ColA colorants from a resolution ResA to a resolution ResB, the method comprising the steps of:
converting said image to a first, intermediate representation having said resolution ResA and an intermediate color set different from said set of ColA colorants; and
converting said image from said first, intermediate representation to a second, intermediate representation having said intermediate color set and said resolution ResB.

10. The method according to claim 9 wherein said first, intermediate representation is a representation in a device independent color space.

11. The method according to claim 9 wherein said first, intermediate representation is a Neugebauer primaries representation.

12. A computer program comprising computer program code means adapted to perform the method according to claim 9 when said program is run on a computer.

13. A computer readable medium comprising program code adapted to carry out the method according to claim 9 when run on a computer.

14. An apparatus for proofing an image, the apparatus having a set of ColB colorants at a resolution ResB, wherein said image is to be output on an output device having a set of ColA colorants at a resolution ResA different from said resolution ResB, the apparatus comprising:
an input device for providing said image in a first representation having said set of ColA colorants and said resolution ResA;
a first converter for converting said image to a second, intermediate representation having said resolution ResA and an intermediate color set that is different from said set of ColA colorants and different from said set of ColB colorants;
a second converter for converting said image from said second, intermediate representation to a third, intermediate representation having said intermediate color set and said resolution ResB; and
a third converter for converting said image from said third, intermediate representation to a fourth representation having said set of ColB colorants and said resolution ResB.

15. The apparatus according to claim 14 wherein said apparatus is an ink jet proofing device.

16. A proof obtained by an apparatus according to claim 14.

17. An apparatus for converting an image having a set of ColA colorants from a resolution ResA to a resolution ResB, the apparatus comprising:
a first converter for converting said image to a first, intermediate representation having said resolution ResA and an intermediate color set different from said set of ColA colorants; and
a second converter for converting said image from said first, intermediate representation to a second, intermediate representation having said intermediate color set and said resolution ResB.
